(19) United States
(12) Patent Application Publication
(10) Pub. No.: US 2008/0229544 A1
(43) Pub. Date: Sep. 25, 2008

(54) Hinge

(75) Inventors: Jia-Hao Hsu, Shulin City (TW); Ting-Hsien Wang, Shulin City (TW)

Correspondence Address: KAMRATH & ASSOCIATES P.A., 4825 OLSON MEMORIAL HIGHWAY, SUITE 245, GOLDEN VALLEY, MN, 55422, US

(73) Assignee: SHIN ZU SHING CO., LTD., Shulin City (TW)

(21) Appl. No.: 11/728,056

(22) Filed: Mar. 23, 2007

(51) Int. Cl. E05D 11/00

(52) U.S. Cl. 16/223; 16/319

(57) ABSTRACT

A hinge is connected between a body and a cover of an electronic merchandise, e.g. a notebook, a mobile phone, an electronic dictionary or the like. The hinge has a pintle having an inner end, an outer end and an axial hole formed through the pintle, an inner bracket with a mounting sleeve mounted rotatably around the inner end of the pintle and an outer bracket mounted securely on the outer end of the pintle. Electronic wires can extend through the axial hole in the pintle to be connected between the cover and the body of the electronic merchandise. So, a special way for wiring is unnecessary to be designed in the electronic merchandise and the volume and weight of the electronic merchandise can be further minimized and lightened.

### BACKGROUND OF THE INVENTION

1. Field of the Invention

The present invention relates a hinge, and more particularly to a hinge that has an axial hole through which electronic wires can be conveniently mounted.

2. Description of Related Art

A hinge is mounted between two elements to allow a relative pivotal rotation between the two elements. For example, a position hinge is generally mounted between a body and a cover of an electronic merchandise, e.g. a notebook, a mobile phone, an electronic dictionary or the like, such that the cover can be pivoted to open or close relative to the body.

A conventional hinge in accordance with the prior art is mounted in an electronic merchandise. The electronic merchandise has a body, a cover and a screen mounted on the cover. The hinge is connected between the body and the cover and has a pintle, an inner bracket and an outer bracket. The pintle has an inner end and an outer end. The inner bracket is disposed in the body of the merchandise and has a mounting sleeve. The mounting sleeve is formed on the inner bracket and is mounted rotatably around the inner end of the pintle. The outer bracket is disposed in the cover of the merchandise and is mounted securely on the outer end of the pintle, so that the outer bracket can rotates relative to the inner bracket.

The cover can be pivoted relative to the body with the relative rotation between the outer bracket and the inner bracket. However, to prevent electronic wires connected between the cover and the body from revealing to outside or inadvertently entwining, and to prevent the hinge from being bound by the electronic wires, a special way for wiring has to be designed in the electronic merchandise to allow the electronic wires to pass through the hinge. Therefore, additional space in the electronic merchandise must be reversed for wiring, and this will increase the volume and weight of the electronic merchandise and is disadvantageous to miniaturization of the electronic merchandise.

### SUMMARY OF THE INVENTION

The primary objective of the present invention is to provide a hinge to mitigate or obviate the aforementioned problems of the conventional hinge.

The hinge in accordance with the present invention is connected between a body and a cover of an electronic merchandise, e.g. a notebook, a mobile phone, an electronic dictionary or the like. The hinge has a pintle having an inner end, an outer end and an axial hole formed through the pintle, an inner bracket with a mounting sleeve mounted rotatably around the inner end of the pintle and an outer bracket mounted securely on the outer end of the pintle. Thus, electronic wires can extend through the axial hole in the pintle to be connected between the cover and the body of the electronic merchandise. So, a special way for wiring is unnecessary to be designed in the electronic merchandise and the volume and weight of the electronic merchandise can be further minimized and lightened. Additionally, the inner bracket and the outer bracket are protected from being bound by the electronic wires neatly received in the axial hole and are capable of smooth rotating.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is an enlarged cross sectional front view of the hinge along line 3-3 in FIG. 4; and

FIG. 4 is a side view in partial section of the hinge in FIG. 1.

### DETAILED DESCRIPTION OF THE PREFERRED EMBODIMENT

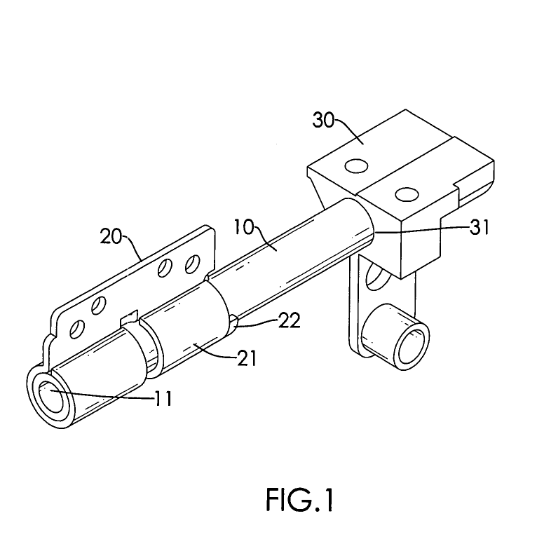

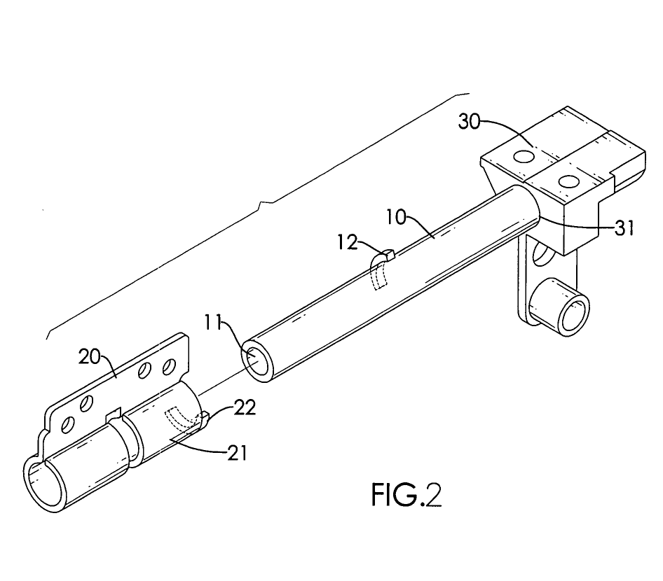

With reference to FIGS. 1 and 2, a hinge in accordance with the present invention is adapted to be mounted in an electronic merchandise, e.g. a notebook, a mobile phone, an electronic dictionary and the like. The electronic merchandise has a body, a cover and a screen mounted on the cover.

The hinge is connected between the body and the cover and has a pintle (10), an inner bracket (20) and an outer bracket (30). The pintle (10) has an inner end, an outer end, an outer wall, an axial hole (11) and a first curved stopper (12). The axial hole (11) is formed axially through the pintle (10) to allow electronic wires to extend through the pintle (10). Thus, electronic wires can be connected between the cover and the body through the axial hole (11) and are prevented from revealing to outside or inadvertently entwining. Accordingly, a special way for wiring is unnecessary to be designed in the electronic merchandise, and volume and weight of the electronic merchandise can be further minimized and lightened. The first curved stopper (12) is formed on and protrudes radially from the outer wall of the pintle (10).

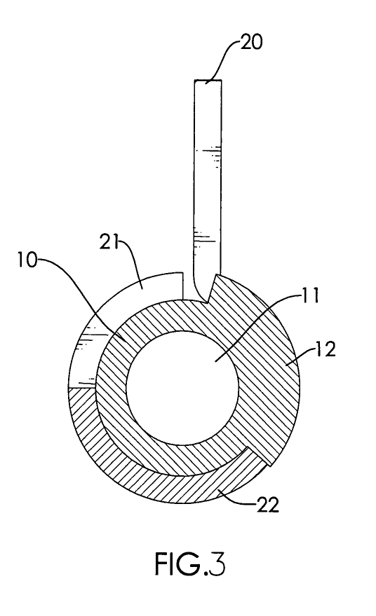

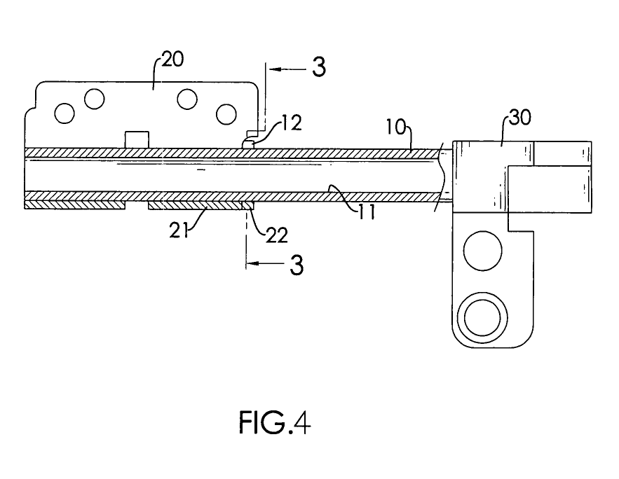

The inner bracket (20) is mounted in the body of the electronic merchandise and has a mounting sleeve (21). With further reference to FIGS. 3 and 4, the mounting sleeve (21) is formed on the inner bracket (20), is mounted rotatably around the inner end of the pintle (10) and has an outer end and a second curved stopper (22). The second curved stopper (22) is formed on and protrudes longitudinally from the outer end of the mounted sleeve (21) and aligns with the first curved stopper (12) along a rotational way of the second curved stopper (22). Thus, the second curved stopper (22) abuts against the first curved stopper (12) when the mounting sleeve (21) rotates to a specific angle.

The outer bracket (30) is mounted in the cover of the electronic merchandise and is mounted securely on the outer end of the pintle (10), so that the outer bracket (30) can rotate relative to the inner bracket (20) and the cover can be pivoted to open or close relative to the body. Further, with the alignment between first curved stopper (12) on the pintle (10) and the second curved stopper (22) on the mounting sleeve (21), the cover is limited to rotate relative to the body within a specific range of angle to keep the screen on the cover in a visible angle. Additionally, because the electronic wires are neatly held in the axial hole (11) in the pintle (10), relative rotation between the inner bracket (20) and the outer bracket (30) is smooth and is kept from interference of the electronic wires. The outer bracket (30) may have a through hole (31). The through hole (31) is formed through the outer bracket (30) and is mounted securely around the outer end of the pintle (10) to allow the electronic wires in the axial hole (11) in the pintle (10) to pass through the outer bracket (30).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge comprising
a pintle having an inner end, an outer end and an outer wall;
an inner bracket having
a mounting sleeve formed on the inner bracket, mounted rotatably around the inner end of the pintle and having an outer end; and
an outer bracket mounted securely on the outer end of the pintle;
wherein the improvement comprises
the pintle further having an axial hole formed axially through the pintle for electronic wires to extend through the pintle.

2. The hinge as claimed in claim 1, wherein
the pintle further has a first curved stopper formed on and protruding radially from the outer wall of the pintle; and
the mounting sleeve further has a second curved stopper formed on and protruding longitudinally from the outer end of the mounted sleeve and aligning with the first curved stopper along a rotational way of the second curved stopper.

3. The hinge as claimed in claim 1, wherein the outer bracket has a through hole formed through the outer bracket and mounted securely around the outer end of the pintle.
